(19) United States
(12) Patent Application Publication
(10) Pub. No.: US 2011/0007897 A1
(43) Pub. Date: Jan. 13, 2011

(54) COMMUNICATION NODE AND NETWORK SYSTEM

(75) Inventors: Tomoko KODAMA, Kariya-shi (JP); Tomohisa Kishigami, Oobu-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/832,490

(22) Filed: Jul. 8, 2010

(30) Foreign Application Priority Data
Jul. 9, 2009 (JP) 2009-162772

(51) Int. Cl. H04L 12/43; H04L 9/00

(52) U.S. Cl. 380/255; 370/458

(57) ABSTRACT

As one aspect, a communication node is provided which transmits data using an assigned frame. The communication node includes a data information storing section which stores information in which plural types of data storage information are related to identifiers, the data storage information indicating a relationship between one or more time slots configuring a frame and data stored in the time slots, and the identifiers identifying the data storage information. The communication node further includes an identifier selecting section which selects one of the identifiers, an identifier transmitting section which transmits the selected identifier included in a predetermined position of the frame, and a data transmitting section which refers to the data storage information corresponding to the selected identifier and transmits data which is specified by the data storage information and is included in a time slot based on the data storage information.

### CROSS REFERENCE TO RELATED APPLICATION

This application is based on and claims the benefit of priority from earlier Japanese Patent Application No. 2009-162772 filed Jul. 9, 2009, the description of which is incorporated herein by reference.

### BACKGROUND OF THE INVENTION

1. Technical Field of the Invention

The present invention relates to a communication node which transmits/receives data using an assigned frame and a network system which includes a plurality of the communication nodes.

2. Related Art

Network systems are known in which a plurality of nodes are connected to a communication line. One example of the network systems is the Controller Area Network (CAN), which performs time-division multiplex communication using a collision detection function. One of this type of network system changes the communication mode from a normal mode to an emergency mode when a communication node requires transmitting an emergency message. This enables the communication node to transmit the emergency message promptly (see Japanese Unexamined Patent Application Publication No. 2006-319381).

According to the technique disclosed in the Japanese Unexamined Patent Application Publication No. 2006-319381, communication is not reset when changing the communication mode to the emergency mode. In this state, the node lengthens a frame by which data can be transmitted. The node embeds the emergency message, together with an ID indicating the type of a message, in the lengthened part of the frame. Then, the node transmits the emergency message and the ID.

In a communication method in which collision detection is performed, such as the communication method of the above network system, data losses are high when transmitting data, and communication speed (communication efficiency) cannot be set to a value equal to or more than a constant value. To increase the communication speed, time-division communication using a fixed time slot method can be considered in which a plurality of communication nodes transmit data using fixed frames which are previously assigned to the respective communication nodes. However, since the above network system requires changing frame sizes in the communication mode, the above network system cannot respond to the time-division communication using a fixed time slot method.

Meanwhile, in a communication node which performs general time-division communication using a fixed time slot method and employs a communication method in which an ID indicating the type of each data is not applied, a slot storing data and the type of the data are previously related to each other. In such a communication node, when transmitting data at emergency time (emergency message) which is different from that at normal time, the relationship between a slot storing data and the type of the data is required to be changed. Hence, the data is required to be transmitted by changing the communication mode between at emergency time and at normal time. In this case, the communication is required to be temporarily reset. When the communication is reset, delay occurs, whereby the transmission of the emergency message is delayed.

### SUMMARY OF THE INVENTION

The present invention has been made in consideration of the foregoing conventional situation, and an object of the present invention is to provide a communication node and a network system in which a plurality of the communication nodes are connected with each other, which can perform time-division communication using a fixed time slot method, and can switch a plurality of communication modes therebetween without delay, the communication modes indicating the type of data to be transmitted.

In order to achieve the object, the present invention provides, as one aspect, a communication node which transmits data using an assigned frame, including: a data information storing section which stores information in which plural types of data storage information are related to identifiers, the data storage information indicating a relationship between one or more time slots configuring a frame and data stored in the time slots, and the identifiers identifying the data storage information; an identifier selecting section which selects one of the identifiers; an identifier transmitting section which transmits the selected identifier included in a predetermined position of the frame; and a data transmitting section which refers to the data storage information corresponding to the selected identifier and transmits data which is specified by the data storage information and is included in a time slot based on the data storage information.

### BRIEF DESCRIPTION OF THE DRAWINGS

In the accompanying drawings:

FIG. 1A is a block diagram schematically showing a configuration of a network system according to the present embodiment;

FIG. 1B is a block diagram showing one communication node with which the network system is configured;

FIG. 2 is a diagram showing the relationship between flag values and meanings of the flags;

FIG. 3 is a flowchart showing a transmitting (transmission) task process;

FIG. 4 is a flowchart showing a receiving (reception) task process;

FIG. 5 is a diagram showing a method for storing data corresponding to the flag value according to the embodiment; and

FIG. 6 is a diagram showing a method for storing data corresponding to the flag value according to a modification of the embodiment.

### DETAILED DESCRIPTION OF THE PREFERRED EMBODIMENTS

Hereinafter, embodiments of the present invention will now be described in connection with the accompanying drawings. In the embodiments set forth below, the components identical with or similar to each other are given the same reference numerals for the sake of omitting redundant explanation.

### Configurations of the Present Embodiment

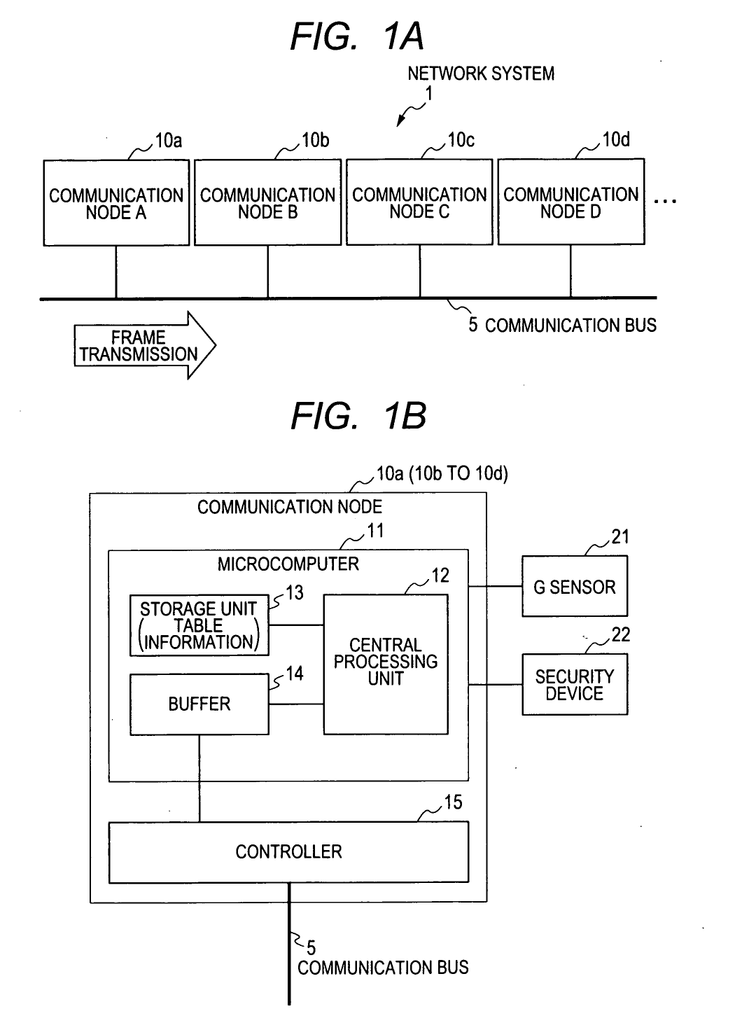

FIG. 1A is a block diagram schematically showing a configuration of a network system according to the present embodiment. FIG. 1B is a block diagram showing one communication node with which the network is system is configured.

A network system 1 of the present embodiment constitutes an in-car network built in a vehicle such as a passenger car. As shown FIG. 1A, a plurality of communication nodes 10a to 10d are connected to a communication bus 5 which acts as a communication line. In the network system 1, the communication nodes 10a to 10d are configured to transmit/receive data to/from each other.

The communication nodes 10a to 10d have a similar hardware configuration. Sensors, devices and the like are connected with respective communication nodes 10a to 10d, but not via the communication bus 5, and have different configurations different from each other. Hereinafter, the configuration of the communication node 10a will be described in detail.

As shown in FIG. 1B, the communication node 10a includes a microcomputer 11 and a controller 15. The microcomputer 11 has a central processing unit 12, a storage unit 13, and a buffer 14. Configurations of the communication nodes 10b to 10d are similar to that of the communication node 10a.

The central processing unit 12 acts as a known CPU or MPU, and performs a predetermined process based on a program or the like stored in the storage unit 13.

The storage unit 13 acts as a ROM or RAM of the microcomputer 11, and stores a program, table information and the like which the central processing unit 12 uses for performing a transmitting task process and a receiving task process described later. In the table information, plural types of data storage information are related to respective flag values (identifiers). The data storage information indicates a relationship between a frame assigned to a time slot and data stored in the frame. The flag values identify the data storage information.

That is, the type of data can be identified by designating the flag value without applying an ID indicating the type of data to each data. Note that the slots in the present embodiment refer to a unit of a period of time (which is assigned to the communication node 10a) during which the communication node 10a can transmit one cycle of data.

In the present embodiment, 64 cycles are defined as one round.

Next, the buffer 14 acts as a storage area in which data transmitted/received between the microcomputer 11 (the central processing unit 12) and the controller 15 is temporarily stored. The controller 15 controls the communication node 10a to transmit/receive data.

When the communication node 10a transmits data to the communication bus 5, the central processing unit 12 stores data to be transmitted in the buffer 14. The controller 15 monitors transmission timing. When the transmission timing arrives, the controller 15 reads data from the buffer 14 and sends the data to the communication bus 5.

When the communication node 10a receives data from the communication bus 5, the controller 15 receives the data first. Then, the central processing unit 12 stores the received data in the buffer 14. The central processing unit 12 accesses the buffer 14 at the timing when the data is required, thereby obtaining the data.

In each of the storage areas (not shown) of the controllers 15 of the communication nodes 10a to 10d, a common time table is stored. The controllers 15 of the communication nodes 10a to 10d perform time-division communication using a fixed time slot method (e.g. Flex Ray (trademark)) based on the time table. According to the time-division communication, data is transmitted using a fixed frame which is previously assigned to the respective communication nodes 10a to 10d.

A G-sensor 21 and a security device 22 are connected to the communication node 10a, but not via the communication bus 5. The G-sensor 21 is a known acceleration sensor. The communication node 10a can detect the acceleration, by which an air bag of the vehicle is expanded, independently of any communication via the communication bus 5.

The security device 22 outputs a detection signal when the vehicle has been unlocked by an unauthorized procedure. The detection signal indicates the fact that the vehicle ha been unlocked by the unauthorized procedure. The security device 22 also can input a signal into the communication node 10a, without using the communication bus 51.

The G-sensor 21 and the security device 22 are directly connected to the microcomputer 11 not via the communication bus 5.

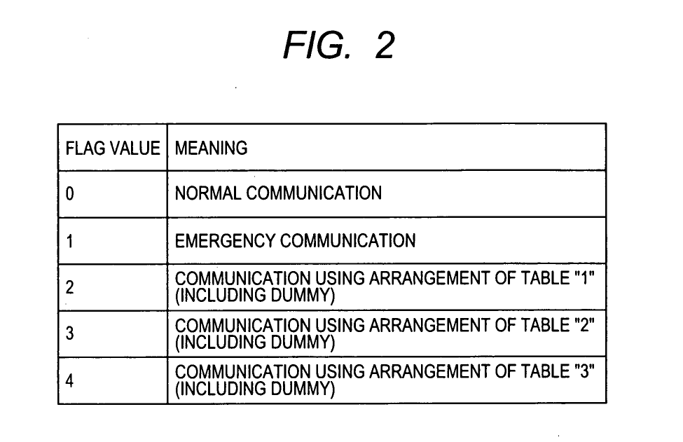

According to the table information stored in the storage unit 13, the flag values and meanings of the flags are related to each other as shown in FIG. 2. As shown in FIG. 2, the flag value “0” is related to normal communication which is neither emergency communication nor communication requiring encryption. The flag value “1” is related to the emergency communication in which emergency messages are so transmitted.

The flag values “2” to “4” are related to encrypted communication in which dummy data is stored in a specific time slot included in a plurality of time slots. Note that the time slot in which the dummy data is stored is determined by the flag value.

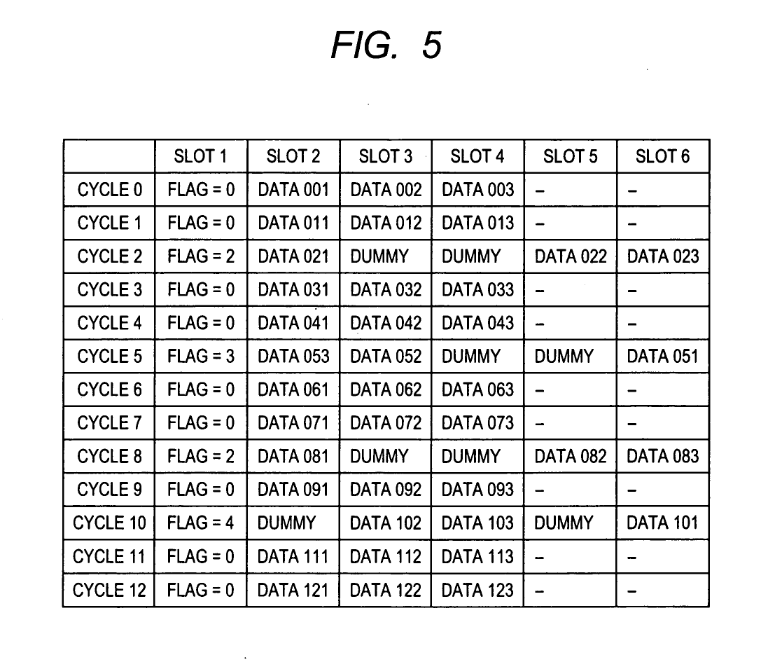

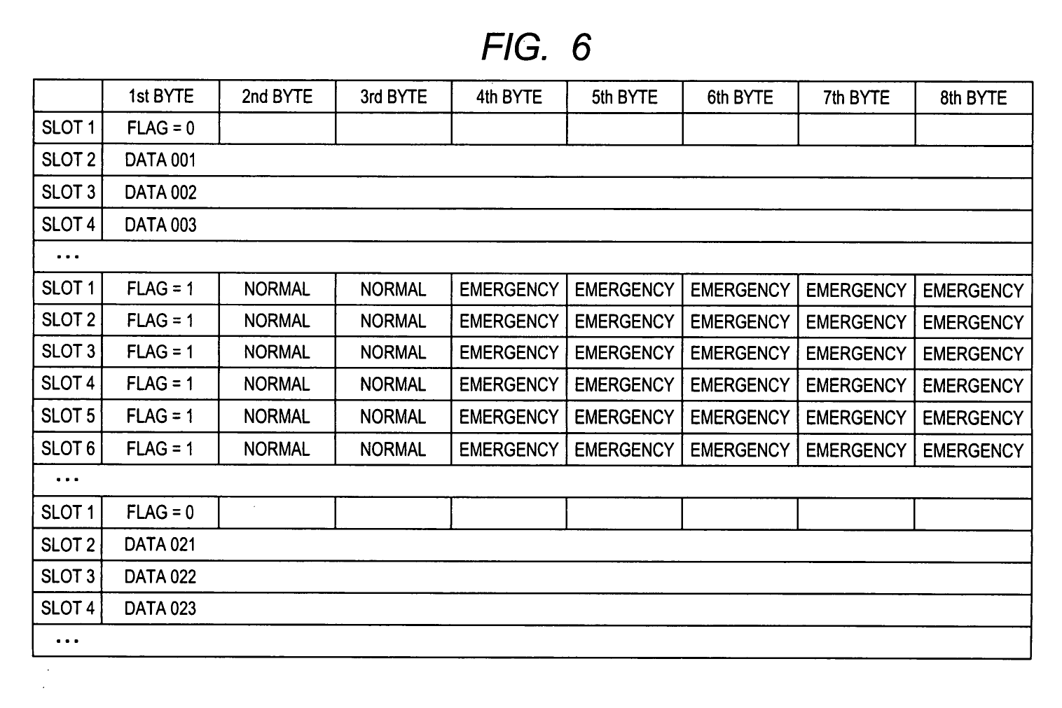

Specifically, in the present embodiment, one frame consisting of 8 bytes is assigned to one slot by which one of the communication nodes 10a to 10d can perform one data transmission. FIGS. 5 and 6 specify structures of frames and time slots. In FIG. 5, slots 1, 2, 4, and 6 are transmitted by a communication node A, and slots 3 and 5 are transmitted by a communication node B.

A data storing method associated with flag values is shown in FIG. 5. When the flag value is “0”, as shown in a row of cycle “0” in FIG. 5, flag value “0” is stored in a predetermined position of slot “1”. Predetermined types of data (data XX1 to XX3: XX indicates a two-digit slot number) are stored in slots “2” to “4”. Empty data (e.g. data consisting of “0”s only) is stored in slots “5” and “6” (normal table).

When the flag value is “2”, as shown in a row of cycle “2” in FIG. 5, flag value “2” is stored in a predetermined position of slot “1”. Data XX1, dummy data, dummy data, data XX2, and data XX3 are sequentially stored in slots “2” to “6” (table “2”). The dummy data may be any value. For example, the dummy data may be determined based on random numbers to prevent the dummy data from being discovered to have obviously no meaning. The data XX1 to XX3 indicate data types (e.g. water temperature, exhaust temperature, and travelling speed).

When the flag value is “3”, as shown in a row of cycle “5” in FIG. 5, flag value “3” is stored in a predetermined position of slot “1”. Data XX3, data XX2, dummy data, dummy data, and data XX1 are sequentially stored in slots “2” to “6” (table “3”).

When the flag value is “4”, as shown in a row of cycle “10” in FIG. 5, flag value “4” is stored in a predetermined position of slot “1”. Dummy data, data XX2, data XX3, dummy data, and data XX1 are sequentially stored in slots “2” to “6” (table “4”).

When the flag value is “1”, for example, flag value “1” is stored in a predetermined position of slot “1”. Emergency messages are stored in slots “2” to “6” (emergency table).

As described above, three types of data are set to cycles “0” to “63” so as to be transmitted. Different types of data or the same type of data may be assigned to the cycles so as to be transmitted. Note that in the same cycle, the same type of data is set so as to be transmitted regardless of the flag values (except “1”).

For example, in cycle “0”, only data 001, data 002, and data 003 are transmitted in both cases where the flag value is “0” and where the flag value is “2”, “3”, or “4”. In these cases, other data such as data 011 and data 023 are not transmitted. Therefore, in the transmitting task process described later, the type of data to be transmitted can be determined before selecting a flag value.

To realize the above configuration, the types of data to be transmitted in respective cycles are stored in the storage unit 13 as the table information.

### Processes According to the Present Embodiment

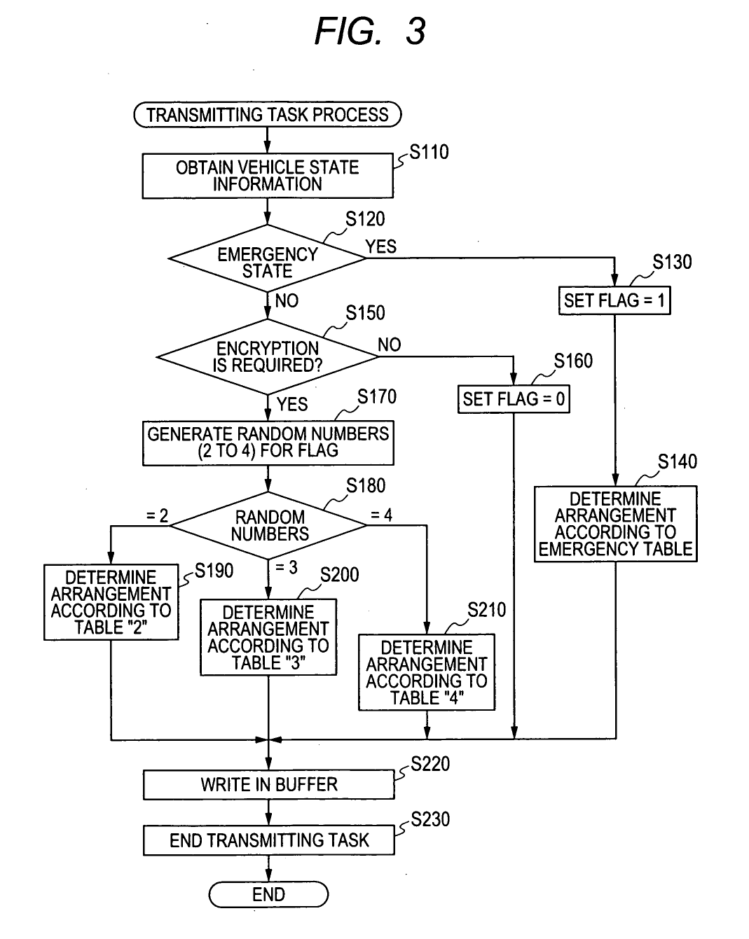

Next, a process performed in the communication nodes 10a to 10d is described with reference to FIG. 3. In the process, data to be transmitted is stored in the buffer 14. FIG. 3 is a flowchart showing the transmitting task process performed by the central processing unit 12.

The transmitting task process is started when the network system 1 is powered on, and is thereafter repeatedly performed in a predetermined cycle. Specifically, as shown in FIG. 3, the central processing unit 12 obtains vehicle state information (S110). Since the G-sensor 21 and the security device 22 are connected to the communication node 10a, the central processing unit 12 obtains signals from the G-sensor 21 and the security device 22. Other communication nodes 10b to 10d receive signals from devices connected thereto.

Next, the central processing unit 12 determines whether or not the vehicle is in an emergency state based on the obtained vehicle state information (S120). In the communication node 10a, it is determined that the vehicle is in an emergency state, for example, in a case where acceleration equal to or more than a predetermined value is detected based on the detection result of the G-sensor 21, or a case where it is detected that the vehicle is unlocked by an unauthorized procedure.

When it is determined that the vehicle is in an emergency state (S120: YES), the central processing unit 12 selects flag value “1” indicating that a predetermined emergency message should be transmitted (emergency communication should be performed) (S130). Then, the central processing unit 12 determines the arrangement of data to be transmitted with reference to the emergency table corresponding to the flag value “1” (S140). Thereafter, the central processing unit 12 proceeds to the process in S220 described later.

Conversely, when it is determined that the vehicle is not in an emergency state (S120: NO), the central processing unit 12 determines whether or not the data to be transmitted should be encrypted (S150). In the present embodiment, it is determined that the data should be encrypted when one of certain conditions is met. The conditions include the condition that a predetermined round or cycle has elapsed, and the condition that there is a possibility that data requiring encryption would be transmitted.

To determine the type of data, the type of data to be transmitted is detected based on the table information, then whether or not the detected type is a predetermined specific type is determined. The types of data corresponding to the specific type are previously listed in the storage unit 13. Whether the data to be transmitted should be encrypted or not may be determined based on whether or not the type of data to be transmitted corresponds to the listed type of data.

When determining that the data to be transmitted should not be encrypted (S150: NO), the central processing unit 12 sets flag value “0” which indicates that the data should be normally transmitted (S160). Thereafter, the central processing unit 12 proceeds to the process in S220 described later. When flag value “0” is set, the arrangement of data is determined with reference to the normal table.

When determining that the data to be transmitted should be encrypted (S150: YES), the central processing unit 12 generates random numbers for a flag (2 to 4: encryption identifier) and set a flag value to the generated random numbers (S170). The random numbers are determined based on the current time or the like. Then, the value of the to generated random numbers is determined (S180).

When the value of the random numbers is “2” (S170: 2), the central processing unit 12 determines the arrangement of data to be transmitted with reference to the table “2” corresponding to the flag value “2” (S190). Thereafter, the central processing unit 12 proceeds to the process in S220 described later.

When the value of the random numbers is “3” (S170: 3), the central processing unit 12 determines the arrangement of data to be transmitted with reference to the table “3” corresponding to the flag value “3” (S200). Thereafter, the central processing unit 12 proceeds to the process in S220 described later.

When the value of the random numbers is “4” (S170: 4), the central processing unit 12 determines the arrangement of data to be transmitted with reference to the table “4” corresponding to the flag value “4” (S210). Thereafter, the central processing unit 12 proceeds to the process in S220 described later.

In S220, the central processing unit 12 sequentially stores the data to be transmitted in the buffer 14 according to the determined arrangement (S220). At this time, the selected flag is included in a predetermined position (i.e. the first time slot) of the frame described above. Then, the central processing unit 12 ends the transmitting task (S230), thereby completing the present process.

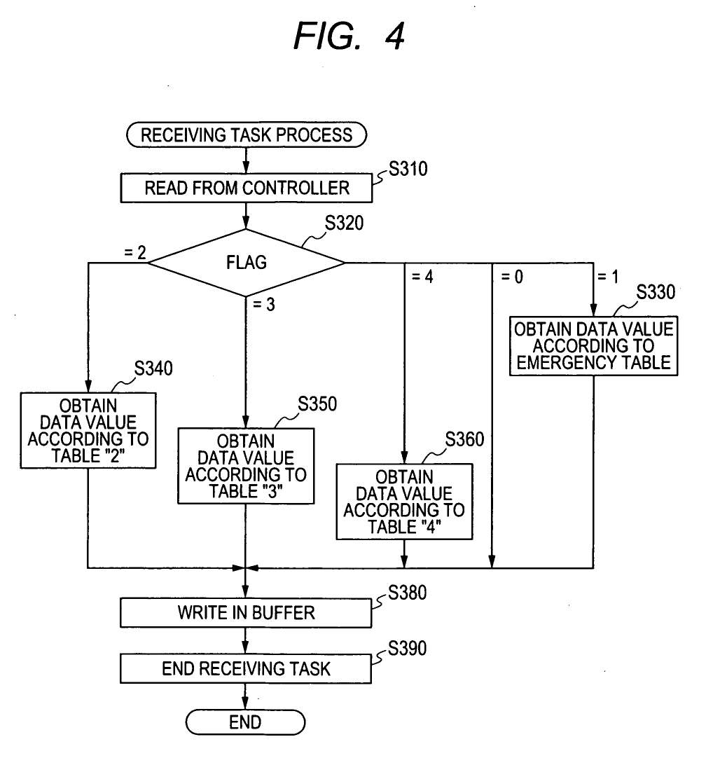

Next, a process performed in the communication nodes 10a to 10d is described with reference to FIG. 4. In the process, data received by the controller 15 is stored in the buffer 14. FIG. 4 is a flowchart showing the receiving task process performed by the central processing unit 12.

The receiving task process is started, as in the case of the transmitting task process, when the network system 1 is powered on. Thereafter, the receiving task process is repeatedly performed in a predetermined cycle. Specifically, as shown in FIG. 4, the central processing unit 12 reads the data received by the controller 15 (S310).

Then, the central processing unit 12 detects a flag value stored in a predetermined position of the received data (S320), and obtains data with reference to the table information corresponding to the flag value (S330 to S360). Specifically, when the flag value is “0” (S320: 0), the is central processing unit 12 immediately proceeds to the process in S380 described later. In this case, the central processing unit 12 identifies the arrangement of data with reference to the normal table, and obtains data according to the arrangement of data.

When the flag value is “1” (S320: 1), the central processing unit 12 identifies the arrangement of data with reference to the emergency table, and obtains data according to the arrangement of data (S330). Thereafter, the central processing unit 12 proceeds to the process in S380 described later. When the flag value is “2” (S320: 2), the central processing unit 12 identifies the arrangement of data with reference to the table “2”, and obtains data according to the arrangement of data (S340). Thereafter, the central processing unit 12 proceeds to the process in S380 described later.

When the flag value is “3” (S320: 3), the central processing unit 12 identifies the arrangement of data with reference to the table “3”, and obtains data according to the arrangement of data (S350). Thereafter, the central processing unit 12 proceeds to the process in S380 described later. When the flag value is “4” (S320: 4), the central processing unit 12 identifies the arrangement of data with reference to the table “4”, and obtains data according to the arrangement of data (S360). Thereafter, the central processing unit 12 proceeds to the process in S380 described later.

In S380, the central processing unit 12 sequentially writes the obtained data in the buffer 14 (S380). Then, the central processing unit 12 ends the receiving task (S390), thereby completing the present process.

Next, one example of data communicated between the communication nodes 10a to 10d will be described with reference to FIG. 5. In the example shown in FIG. 5, encryption is performed every three cycles basically. Specifically, in cycles “2”, “5”, and “8”, flags “2” to “4” are selected. In cycles “0”, “1”, “3”, “4”, “6”, and “7”, flag “0” is is selected.

As in the case of cycle “10”, when the data to be transmitted includes data to be encrypted, flags “2” to “4” are selected regardless of three cycles.

### Effects of the Present Embodiment

In the network system 1 described above, the storage units 13 of the communication nodes 10a to 10d store the table information in which the plural types of data storage information are related to the flags. The data storage information indicates a relationship between one or more time slots configuring a frame and data stored in the time slots. The flags identify the data storage information. The central processing units 12 of the communication nodes 10a to 10d perform the transmitting task process in which a selected flag is included in a predetermined position of the frame and is transmitted to other communication nodes 10a to lad. In addition, the central processing units 12 refer to the data storage information corresponding to the selected flag value, and incorporate the data specified by data storage information into a time slot based on the data storage information. Then, the central processing units 12 transmit the data to other communication nodes 10a to 10d.

According to the network system 1 described above, the communication nodes 10a to 10d can change the type of data to be transmitted (i.e. communication mode) by only changing the flag value. When changing the communication mode, the communication state is not required to be reset. Therefore, a plurality of communication modes can be switched therebetween without delay.

In addition, the communication nodes 10a to 10d of the present embodiment can respond to not only the time-division communication using a collision detection function, which is performed by CAN and the like, but also the time-division communication using a fixed time slot method.

In the network system 1, the central processing unit 12 obtains external data showing external states of the communication nodes 10a to 10d, and determines whether or not the vehicle is in an emergency state based on the external data. When it is determined that the vehicle is in an emergency state, the central processing unit 12 selects the flag value indicating that a predetermined emergency message should be transmitted.

According to the network system 1 described above, when it is determined that the vehicle is in an emergency state, a flag value is selected which is for referring to the data storage information to which the indication of transmitting the emergency message is related. Therefore, the communication nodes 10a to 10d can promptly transmit the emergency message. Other communication nodes 10a to 10d receiving the data from the communication nodes 10a to 10d can easily recognize the transmission of the emergency message by detecting the flag.

In addition, the network system 1 is installed in the vehicle. The central processing unit 12 obtains a detection result showing presence/absence of the unauthorized rewriting of data included in the vehicle (manipulation) or presence/absence of an operation for unauthorized entry into the vehicle (unauthorized operation). When a manipulation or unauthorized operation is detected, it is determined that the vehicle is in an emergency state.

According to the network system 1, when the manipulation of data or the unauthorized operation is detected, an emergency message can be transmitted. Therefore, other devices receiving the emergency message can perform predetermined alarm process and security process. According to the alarm process and the security process, other devices which have received the emergency message give an alarm to the owner of the vehicle, sound an alarm, or set the vehicle not to be driven.

In addition, the storage unit 13 of the network system 1 stores data storage information including information which indicates storing dummy data in a specific time slot included in one or more time slots. The stored data storage information is related to an encryption flag which is one type of flag.

According to the network system 1, when the encryption flag is selected, data can be encrypted.

The central processing unit 12 of the network system 1 detects the type of data to be transmitted, and determines whether or not the detected type is a predetermined specific type. Then, when determining that the type is the specific type, the central processing unit 12 selects the encryption flag.

According to the network system 1 described above, when it is determined, from the type of the data, that there is a possibility that the data to be transmitted should be encrypted, the encryption flag can be selected.

In addition, the communication nodes 10a to 10d of the network system 1 include the controller 15 which receives data transmitted from other communication nodes 10a to 10d. The central processing unit 12 extracts a flag value stored in a predetermined position of the received data. The central processing unit 12 identifies the type of the received data with reference to the data storage information corresponding to the extracted flag value.

According to the network system 1 described above, the type of data to be received (i.e. communication mode) can be changed based on the received flag value. When changing the communication mode, the communication state is not required to be reset. Therefore, a plurality of communication modes can be switched therebetween without delay.

In addition, the network system 1 can respond to not only the time-division communication using a collision detection function, which is performed by CAN and the like, but also the time-division communication using a fixed time slot method.

The communication nodes 10a to 10d of the network system 1 include two functions. One of the functions is to transmit data while changing the communication mode based on the flag value. The other of the functions is to receive data. Therefore, the communication nodes 10a to 10d can mutually communicate with other communication nodes 10a to 10d while changing the communication mode.

In the above embodiment, the storage unit 13 corresponds to a data information storing means (section). The controller 15 corresponds to a data receiving means (section), a data transmitting means (section), and an identifier transmitting means (section). The process in S110 of the transmitting task process corresponds to an external data obtaining means (section). The process in S120 of the transmitting task process corresponds to an emergency state determining means (section).

The processes in S130, S160, and S170 correspond to an identifier selecting means (section). The process in S150 corresponds to a data type determining means (section). The process in S220 corresponds to an identifier transmitting means (section) and a data transmitting means (section). The process in S320 of the receiving task process corresponds to an identifier extracting means (section). The processes in S340 to S360 correspond to a data type identifying means (section).

### Other Embodiments

It will be appreciated that the present invention is not limited to the configurations described above, but any and all modifications, variations or equivalents, which may occur to those who are skilled in the art, should be considered to fall within the scope of the present invention.

Although one flag value is stored every one cycle in the above embodiment, the flag value may be stored every unit other than the cycle. The unit for storing the flag value may be changed depending on the flag value.

In one example shown in FIG. 6, when the flag value is “0” (i.e. not “1”), one flag value is stored every one cycle. However, when the flag value is “1”, one flag value is stored every one slot. Specifically, when the flag value is “1”, one flag value is stored in the first byte of the slots, and predetermined data is stored in the second and later byte.

According to the above configuration, when the communication mode is required to be switched more frequently, for example, at emergency time, the data to be transmitted can be changed more frequently. When the data is required to be transmitted efficiently, for example, at normal time, more data can be transmitted.

Hereinafter, aspects of the above-described embodiments will be summarized.

In the communication node of the embodiment, a data information storing section stores information in which plural types of data storage information are related to identifiers, the data storage information indicating a relationship between one or more time slots configuring a frame and data stored in the time slots, and the identifiers so identifying the data storage information. The identifier transmitting section transmits the identifier, which is selected by the identifier selecting section and is included in a predetermined position of the frame, to another communication node constituting a network system. In addition, the data transmitting section refers to the data storage information corresponding to the selected identifier and transmits data, which is specified by the data storage information and is included in a time slot based on the data storage information, to another communication node.

According to the communication node described above, the type of data to be transmitted (i.e. communication mode) can be changed only by changing the flag value. When changing the communication mode, the communication state is not required to be reset. Therefore, a plurality of communication modes can be switched therebetween without delay.

In addition, the communication node of the embodiment can respond to not only the time-division communication using a collision detection function, which is performed by CAN and the like, but also the time-division communication using a fixed time slot method.

The above communication node may include an external data obtaining section which obtains external data showing an external state of the communication node, and an emergency state determining section which determines whether or not an emergency state has arisen based on the obtained external data. When the emergency state determining section determines that the emergency state has arisen, the identifier selecting section may select an identifier indicating that a predetermined emergency message should be transmitted.

According to the communication node described above, when it is determined that the vehicle is in an emergency state, an identifier is selected which is for referring to the data storage information to which the indication of transmitting the emergency message is related. Therefore, the communication node can promptly transmit the emergency message. Another communication node receiving the data from the communication node can easily recognize the transmission of the emergency message by detecting the identifier.

When a network system including the communication node is installed in a vehicle, the external data obtaining section obtains a detection result showing presence/absence of the unauthorized rewriting of data included in the vehicle (manipulation) or presence/absence of the operation for unauthorized entry into the vehicle (unauthorized operation). When the manipulation or the unauthorized operation is detected, the emergency state determining section may determine that the vehicle is in an emergency state.

According to the communication node described above, when the manipulation of data or the unauthorized operation is detected, an emergency message can be transmitted. Therefore, other devices receiving the emergency message can perform predetermined alarm process and security process. According to the alarm process and the security process, other devices which have received the emergency message give an alarm to the owner of the vehicle, sound an alarm, or set the vehicle not to be driven.

In the above communication node, the data information storing section may store the data storage information including information which indicates storing dummy data in a specific time slot included in the one or more time slots, the stored data storage information being related to an encryption identifier which is one of the identifiers.

According to the communication node described above, since the dummy data is inserted when the encryption identifier is selected, a person who does not know the arrangement of the data cannot decode the meaning of the data. That is, the data can be encrypted.

The communication node may further include a data type determining section which detects the type of data to be transmitted and determines whether or not the detected type is a predetermined specific type. The identifier selecting section may select the encryption identifier when the data type determining section determines that the detected type is the specific type.

According to the communication node described above, when it is determined, from the type of the data, that there is a possibility that the data to be transmitted should be encrypted, the encryption identifier can be selected.

Another communication node includes the data information storing section, a data receiving section which receives data transmitted from another communication node; an identifier extracting section which to extracts an identifier stored in a predetermined position of the received data; and a data type identifying section which identifies the type of the received data with reference to the data storage information corresponding to the extracted identifier.

According to the communication node described above, the type of data to be received (i.e. communication mode) can be changed based on the received identifier. When changing the communication mode, the communication state is not required to be reset. Therefore, a plurality of communication modes can be switched therebetween without delay.

In addition, the communication node of the present embodiment can respond to not only the time-division communication using a collision detection function, which is performed by CAN and the like, but also the time-division communication using a fixed time slot method.

Another communication node includes the data information storing section, the identifier selecting section, the identifier transmitting section, the data transmitting section, the data receiving section, the identifier extracting section, and the data type identifying section.

The communication node described above includes two functions. One of the functions is to transmit data while changing the communication mode based on the identifier. The other of the functions is to receive data. Therefore, the communication node can mutually communicate with another communication node while changing the communication mode.

The network system of the embodiment is configured by connecting a plurality of the communication nodes with each other via a network.

According to the network system described above, a system can be configured in which data communication is performed while changing the communication mode based on the identifier.

The above sections (except the data information storing section) constituting one of the above the communication modes can be implemented as a computer program.

What is claimed is:

1. A communication node which transmits data using an assigned frame, comprising:
a data information storing section which stores information in which plural types of data storage information are related to identifiers, the data storage information indicating a relationship between one or more time slots configuring a frame and data stored in the time slots, and the identifiers identifying the data storage information;
an identifier selecting section which selects one of the identifiers;
an identifier transmitting section which transmits the selected identifier included in a predetermined position of the frame; and
a data transmitting section which refers to the data storage information corresponding to the selected identifier and transmits data which is specified by the data storage information and is included in a time slot based on the data storage information.

2. The communication node according to claim 1, further comprising:
an external data obtaining section which obtains external data showing an external state of the communication node; and
an emergency state determining section which determines whether or not an emergency state has arisen based on the obtained external data, wherein
when the emergency state determining section determines that the emergency state has arisen, the identifier selecting section selects an identifier indicating that a predetermined emergency message should be transmitted.

3. The communication node according to claim 1, wherein the data information storing section stores the data storage information including information which indicates storing dummy data in a specific time slot included in the one or more time slots, the stored data storage information being related to an encryption identifier which is one of the identifiers.

4. The communication node according to claim 3, further comprising a data type determining section which detects the type of data to be transmitted and determines whether or not the detected type is a predetermined specific type, wherein
the identifier selecting section selects the encryption identifier when the data type determining section determines that the detected type is the specific type.

5. A communication node which transmits data using an assigned frame, comprising:
a data information storing section which stores information in which plural types of data storage information are related to identifiers, the data storage information indicating a relationship between one or more time slots configuring a frame and data stored in the time slots, and the identifiers identifying the data storage information;
a data receiving section which receives transmitted data;
an identifier extracting section which extracts an identifier stored in a predetermined position of the received data; and
a data type identifying section which identifies the type of the received data by referring to the data storage information corresponding to the extracted identifier.

6. A communication node which transmits data using an assigned frame, comprising:
a data information storing section which stores information in which plural types of data storage information are related to identifiers, the data storage information indicating a relationship between one or more time slots configuring a frame and data stored in the time slots, and the identifiers identifying the data storage information;
an identifier selecting section which selects one of the identifiers;
an identifier transmitting section which transmits the selected identifier included in a predetermined position of the frame;
a data transmitting section which refers to the data storage information corresponding to the selected identifier and transmits data which is specified by the data storage information and is included in a time slot based on the data storage information;
a data receiving section which receives transmitted data;
an identifier extracting section which extracts an identifier stored in a predetermined position of the received data; and
a data type identifying section which identifies the type of the received data with reference to the data storage information corresponding to the extracted identifier.

7. A network system which is configured by connecting a plurality of communication nodes with each other via a network, each of the communication nodes transmitting data using an assigned frame and comprising:
a data information storing section which stores information in which plural types of data storage information are related to identifiers, the data storage information indicating a relationship between one or more time slots configuring a frame and data stored in the time slots, and the identifiers identifying the data storage information;
an identifier selecting section which selects one of the identifiers;
an identifier transmitting section which transmits the selected identifier, which is included in a predetermined position of the frame, to another one of the communication nodes; and
a data transmitting section which refers to the data storage information corresponding to the selected identifier and transmits data, which is specified by the data storage information and is included in a time slot based on the data storage information, to another one of the communication nodes.

8. The network system according to claim 7, wherein each of the communication nodes further comprising:
a data receiving section which receives data transmitted from another one of the communication nodes;
an identifier extracting section which extracts an identifier stored in a predetermined position of the received data; and
a data type identifying section which identifies the type of the received data with reference to the data storage information corresponding to the extracted identifier.
